(19) United States
(12) Patent Application Publication
(10) Pub. No.: US 2010/0006082 A1
(43) Pub. Date: Jan. 14, 2010

(54) WIRE SLICING SYSTEM

(75) Inventors: Lukasz A. Glinski, Worcester, MA (US); David Graham, Oakham, MA (US); Edward L. Lambert, Westboro, MA (US); Krishnamoorthy Subramanian, Lexington, MA (US)

Correspondence Address: HOUSTON ELISEEVA, 4 MILITIA DRIVE, SUITE 4, LEXINGTON, MA, 02421, US

(73) Assignees: SAINT-GOBAIN ABRASIVES, INC., Worcester, MA (US); SAINT-GOBAIN ABRASIFS, Conflans Sainte Honorine (FR)

(21) Appl. No.: 12/499,966

(22) Filed: Jul. 9, 2009

Related U.S. Application Data
(60) Provisional application No. 61/079,928, filed on Jul. 11, 2008.

(51) Int. Cl. B28D 5/00; B28D 1/08; B28D 1/06

(52) U.S. Cl. 125/16.02; 451/449; 451/41; 125/38; 83/651.1

(57) ABSTRACT

A wire slicing system and method for using it include one or more of the following features: arrangements and/or operations that relate to handling the wire; apparatus and methods that relate to wire tensioning; equipment and techniques for manipulating the workpiece; arrangements and/or operations designed for cooling and swarf (debris) removal; controls and/or automation that can be used in conjunction with these features.

### RELATED APPLICATIONS

This application claims the benefit under 35 USC 119(e) of U.S. Provisional Application No. 61/079,928, filed on Jul. 11, 2008, which is incorporated herein by reference in its entirety.

### BACKGROUND OF THE INVENTION

The demand for high quality, ultra-thin wafers cut from blocks or ingots of hard, brittle crystals and ceramics continues to challenge cutting machine and abrasive manufacturers. Traditionally, these wafers have been produced using annular (circular) sawing or multi-wire slicing (MWS) using loose diamond abrasive.

Several disadvantages are associated with conventional methods of cutting thin wafers from crystal blocks. With annular sawing, also called “ID sawing”, the wafers are cut individually from the workpiece. While the quality of ID-sawed wafers is good, this one-piece-at-a-time approach translates into long machining times and slow production rates. Furthermore, sizes of work pieces that can be handled with ID saws often are limited.

For these and other reasons, bare-wire with abrasive slurry MWS is the more commonly used method for producing thin wafers for the electronics industry. While MWS enables cutting widths as low as 140-200 microns in diameter, this method also presents challenges. For instance, loose abrasive dulls quickly and slows the rate of material removal, so the abrasive slurry must be handled carefully throughout the process to ensure grain sharpness and concentration consistency. Getting loose abrasive slurry consistently into long or deep cuts (over 400 mm or 16 in.) presents additional problems. And since the slurry often is treated as waste, disposal or recycling add to the overall manufacturing costs. Finally, this method generally achieves slow material removal rates, especially during the slicing of hard materials where loose abrasives tend to wear the relatively soft steel wire before the harder work piece.

Increasingly, wafers are being produced using fixed-abrasive wire technology in a single- or multi-wire machine set-up. Although abrasive-coated wires offer many advantages over traditional approaches, a need continues to exist for slicing arrangements and operations that leverage the benefits of fixed abrasive wire technology to improve the quality of the cut and provide a wider range of cut geometries. A need also continues to exist for slicing machines or parts thereof that can provide increased versatility, reduced wire breakages, improved workpiece handling capabilities, increased speeds, increased process controls and so forth.

### SUMMARY OF THE INVENTION

In many embodiments the invention relates to slicing operations that employ wire sawing. In preferred implementations the slicing operations are conducted using fixed abrasive, e.g., diamond, wires. Features and techniques described herein can be used individually or in any combination. In some embodiments of the invention, for example, one or more of these features and/or techniques are incorporated in a wire slicing system or machine. At least some of the features and techniques described herein can also be used in conjunction with equipment other than implementations of a wire slicing system or machine.

Several aspects of the invention relate to low bending and low tortional stress spooling and wire handling. In one embodiment, a wire handling assembly for a fixed abrasive wire slicing operation includes one or more wire spools, wire guides and wire tensioners, wherein a wire path defined by said wire spools, wire guides and wire tensioners is essentially planar. In another embodiment, a wire handling assembly for a fixed abrasive wire slicing operation includes one or more contact elements, at least one of the contact elements having a wire contact diameter greater than 100 millimeters (mm). In a further embodiment, a fixed abrasive wire slicing system includes a wire path that is essentially planar. In yet another embodiment, a fixed abrasive wire slicing system includes a large diameter wire path.

Other aspects of the invention relate to dual drum arrangements such as single layer dual drum spooling and other dual drum arrangements. In one embodiment, a fixed abrasive wire system includes a single layer dual drum spooling assembly which has a first roller and a second roller. The rollers are operationally linked to one another, with one of the rollers being connected to a motor. In another embodiment, a fixed wire abrasive system includes a dual drum assembly for controlling a wire pitch on both drums. The assembly has a first roller and a second roller, the rollers being operationally linked to one another; at least one of the first roller and the second roller is connected to a motor. A further embodiment includes a drum spooling arrangement wherein each of a dual drum system is linked to a servo motor. In yet another embodiment a method for providing wire to a cutting zone in a fixed abrasive wire slicing operation includes moving the fixed abrasive wire back and forth between two drums, wherein pitch is controlled in both drums. In a further embodiment a method for providing wire to a cutting zone in a fixed abrasive wire slicing operation includes rotating a first roller, wherein the first roller is operationally linked to a second roller, to wind wire on said rollers.

Still other aspects of the invention relate to a constant force wire bow sensor. In one embodiment, a method for monitoring or controlling a wire bow angle during a wire slicing operation includes selecting a set value for a bow angle caused by contact between a wire and a workpiece; and detecting an actual bow angle during the wire slicing operation to determine if the actual bow angle reaches said set value. In another embodiment, a system for monitoring or controlling a bow angle on a slicing wire contacting a workpiece includes a detector for sensing movement of a device tracking the bow angle of the wire at the slicing zone.

Further aspects of the invention relate to curvilenear slicing of thin shapes and/or complex geometry profiling. In one embodiment, a process for producing a curvilinear cut in a workpiece includes controlling a first axis and a second axis during a wire slicing operation, while interpolating the first axis as wire is fed through the workpiece. In another embodiment, a fixed abrasive wire slicing system includes linear stages for controlling, respectively, a first axis and a second axis and a table for rotating a workpiece during a slicing operation.

Still other aspects of the invention relate to wire slicing workpiece rocking and rotation system. In one embodiment, a process for cutting a workpiece includes rocking the workpiece while the workpiece is being fed into a fixed abrasive wire. In another embodiment, an assembly for a fixed abrasive wire slicing system includes a first linear stage and a rotary stage mounted on a second linear stage, wherein the first linear stage is different from the second linear stage.

Preferred aspects of the invention relate to a fixed abrasive wire slicing system including one or more of: a) an essentially planar wire path for delivering a fixed abrasive wire to a cutting zone; b) a contact element having a wire contact diameter greater than 100 mm; c) a single layer dual drum spooling assembly including mechanically linked rollers, one of said rollers being connected to a motor; d) a system for monitoring a bow angle on a slicing wire contacting a workpiece, wherein the system for monitoring the bow angle includes detector for sensing movement of a device tracking bowing of the wire at the slicing zone; and e) an assembly including a first linear stage and a rotary stage mounted on a second linear stage, wherein the second linear stage is different from the first linear stage.

The slicing system, subsystems and operations described herein are particularly well suited in wafering or cropping operations and can be employed to cut ceramics, in particular hard and brittle ceramics, metals, organics and other workpieces. When compared to existing slicing machines, specific implementations of the invention can provide fast cutting rates and cuts of improved quality. For instance, a fixed diamond abrasive wire slicing machine according to preferred embodiments of the invention can reach a wire speed of 15 m/s and can have a tension range of up to 50N.

Advantageously, implementations of the invention provide unique handling of the workpiece which allows for versatility in the slicing process. An ingot can be moved up and down, forward and backward as well as rotated or rocked during slicing. By practicing aspects of the invention, wafers can be sliced along curvilinear cuts or in complex geometries. Equalizing the contact length of the wire throughout the cutting process, maximizing the force per grit and increasing the relative wire to workpiece contact speed are other benefits associated with some implementations of the invention.

Embodiments of the invention that address handling of the wire and features relating to drum arrangements, wire guides and tensioners can reduce or minimize wire damage caused by wire on wire abrasion and/or can prevent or minimize wire breakages and production interruptions. Advantages in slicing also are obtained through utilizing a constant force wire bow sensor system. Implementations of the invention also can benefit from coherent jet cooling technology and simultaneous implementations of two or more embodiments of the invention create significant advantages over existing platforms.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are views of a fixed plane arrangement for wire guides and wire tensioners configured according to one embodiment of the present invention.

FIGS. 2A and 2B are black and white photographs showing large contact diameter wire guides according to one embodiment of the invention.

FIG. 3 is a view of a large diameter wire guide according to one implementation of the invention.

FIG. 4 is a view of a large contact diameter spooling device according to one embodiment of the invention.

FIG. 5 is a black and white photograph of a single layer dual drum spooling assembly according to one embodiment of the invention.

FIGS. 6A, 6B, and 6C are black and white photographs showing close-up views of the timing belt and means for securing the rollers in a single layer dual drum spooling assembly according to one embodiment of the invention.

FIG. 7 is a view of a single layer dual drum spooling assembly according to one embodiment of the invention.

FIG. 8 is a view of a portion of the single layer dual drum spooling assembly shown in FIG. 7.

FIG. 9A is a view of a single layer dual drum spooling assembly, according to one embodiment of the invention, mounted on a linear stage.

FIG. 9B is an illustration of various linear stages and axes for an arrangement of a single layer dual drum spooling assembly and workpiece according to one embodiment of the invention.

FIGS. 10 and 11 are views of a ball bearing roller that can be employed in a wire constant force sensor system according to one embodiment of the invention.

FIG. 12 is an exploded view of an embodiment of a constant force sensor system including a ball bearing roller such as shown in FIGS. 10 and 11.

FIG. 13 is a view of a three axis positioning system on a wire slicing machine according to the invention.

FIG. 14 is a diagram illustrating curvilinear slicing according to one embodiment of the invention.

FIG. 15 is a diagram illustrating complex geometry profiling according to one embodiment of the invention.

FIG. 16 is a three-dimensional image of an entire ingot movement and feeding assembly according to one embodiment of the invention.

FIG. 17 is a view of a rotating table with a protruding work holding tooling that can be employed in one embodiment of the invention.

FIG. 18 is a view of a mounted workpiece that can be rocked on a rotary stage such as the rotating table shown in FIG. 17.

FIG. 19 is an illustration of (1) linear infeed cutting; (2) rotation and infeed cutting; and (3) rocking and infeed cutting.

FIG. 20 is a three-dimensional image of several components according to embodiments of the invention, assembled in a 3D virtual space.

FIGS. 21 and 22 are views of an abrasive wire slicing system according to embodiments of the invention.

### DETAILED DESCRIPTION OF THE PREFERRED EMBODIMENTS

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

The invention generally relates to equipment and processes that can be employed during wire sawing, also referred to as wire slicing operations.

Wire slicing generally is carried out to cut or shape a workpiece and includes contacting the workpiece with at least one wire. In many implementations, the wire is a fixed abrasive wire in which abrasive grains or grits are bonded to a core made of materials such as stainless steel, other suitable metals, and so forth. In many implementations, the abrasive grains are superabrasives, including, e.g., natural or synthetic diamond or cubic boron nitride (CBN). Bonding can be realized through brazing, electroplating or other suitable processes employed to secure the abrasive material to the core. In many embodiments of the invention, particularly preferred are Saint-Gobain Abrasives' Winter diamond wires. Typically these diamond wires are available in diameters within the range of from about 180 microns (μm), on a 150 μm core, to about 430 μm, on a 300 μm core. Other abrasive coated wires can be employed, as can be other suitable diameters. Aspects of the invention also can utilize bare wires, for instance in conjunction with abrasive slurries, as well as other types of wires.

In many cases the wire is wound on a spool or reel. Many kinds of wire spools are commercially available and wire also can be provided in customized arrangements.

In specific embodiments, the invention relates to a wire slicing or wire sawing system, also referred to herein as a wire slicing or wire sawing machine. Wire slicing machines can be designed to address needs ranging from simple operations, such as cutting the occasional workpiece, to industrial scale manufacturing processes or complex machining. Of particular interest here are slicing systems suitable to process hard and brittle crystals and ceramics, such as those employed to produce wafers for the microelectronic, optoelectronic photovoltaic and other industries. Examples of specific materials the can be processed include, for instance, garnet ((SiO₄)₃), sapphire (Al₂O₃), silicon carbide (SiC), yttrium metal garnet (YAG), gallium nitride (GaNi), aluminum gallium nitride (AlGaNi), gallium arsenide (GaAs), indium gallium arsenide (InGaAs), indium gallium nitride (InGaNi), germanium, and so forth.

The wire slicing system disclosed herein can be utilized to process workpieces that are ingots having round or square cross-sections as well as workpieces having a spherical, polygonal, e.g., square, irregular, or other shapes. The system can be adapted for both single- and multi-wire operations, in which the work piece, e.g., ingot, is sliced by a single wire.

The system also can be employed in multi-wire arrangements in which the workpiece is sawed by a wire web to produce, in one step and preferably simultaneously, a plurality of slices, e.g., wafers. As used herein, the words “multi” and “plurality” refer to more than one element. Slicing ingots to produce wafers also is known as “wafering”. During the operation of many types of multi-wire saws, a fresh single wire is directed from a supply spool to guide rollers which are grooved to a constant pitch and arrangements that use two or more, e.g., four such rollers can be employed to create a wire web. An output or take-up spool collects the used wire. Wire is spooled between two rollers in a back and forth manner.

In various implementations, the wire slicing system disclosed herein addresses one or more of the following: arrangements and/or operations that relate to directing the slicing tool, e.g., diamond wire, to and from the cutting site or zone; apparatus and methods that relate to wire tensioning; equipment and techniques for manipulating the workpiece; arrangements and/or operations designed for cooling and swarf (debris) removal; controls and/or automation that can be implemented; and so forth. These are discussed in turn.

Several embodiments of the invention relate to assemblies and techniques employed for handling the wire, preferably a fixed abrasive wire.

Existing fixed abrasive wire machines use complex spool, guide and tensioners that typically move the wire through a three dimensional path, often resulting in wire bending and torsional stresses that can interrupt production and lower the useful life of the wire through breakage.

These tortional stresses and other problems associated with existing designs are addressed by the planar arrangement and/or low bending radius wire guide and spooling described herein.

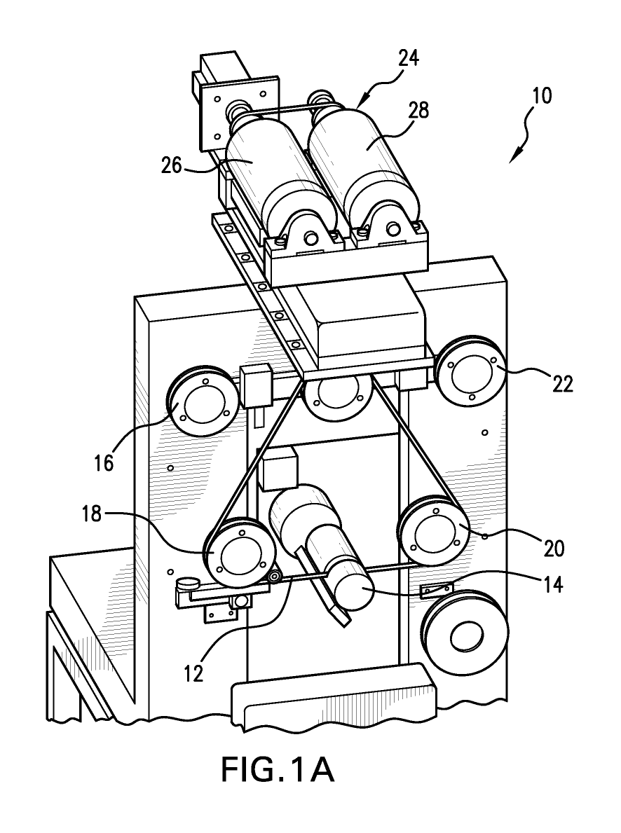

In one embodiment, the arrangement provides a dynamic wire path that is planar or essentially planar. As used herein, the term “wire path” or “wire pathway” refers to the circuit traveled by the wire between two spooling drums and the cutting zone. Typically the path traveled by the wire includes wire contact elements, which are devices such as wire spools, wire guides or wire tensioners and so forth, used to direct the wire along its path. Shown in FIGS. 1A and 1B, for example, is assembly 10 used to provide abrasive wire length 12 for slicing ingot 14. For feeding fresh wire to the slicing zone and for removing used wire, assembly 10 includes devices 16, 18, 20 and 22, with devices 16 and 22 acting as wire tension pulleys or wire tensioners, and devices 18, 19 and 20 acting as wire guides. Wire is supplied from a spooling device, e.g., single layer dual drum spooling assembly 24, further described below, which includes rollers 26 and 28. Conventional spooling devices also can be employed. As illustrated in FIGS. 1A and 1B, the wire path traveled by the wire on roller 26, wire guides 18, 19 and 20, wire tensioners 16 and 22 and roller 28 is planar or essentially planar. The arrangement of wire and spooling components described herein reduces or minimizes tortional and bending stresses.

In other embodiments, potential tortional stresses are addressed by providing one and preferably more wire contact elements, e.g., wire guides, spooling, wire tensioners, etc., that have relatively large contact diameters. The wire contact elements can have a contact diameter that is at least 100 millimeters (mm), e.g., greater than about 100 mm, preferably greater than about 200 mm and more preferably greater than about 300 mm. Wire paths or pathways that do not include wire contact elements having a diameter smaller than about 100 mm are referred to herein as “large diameter” paths or pathways.

In specific examples, wire guides or wire tensioners have a contact diameter within the range of from about 100 (mm) to about 400 mm; wire spooling devices have a contact diameter within the range of from about 150 mm to about 400 mm. For instance, wire guides, tensioners and wire spool drums employed in a fixed abrasive wire slicing machine can be 125 and 150 millimeters mm, respectively.

In contrast, wire guides and wire spool drums typically used in existing fixed abrasive wire slicing machines have a contact diameter of 50 mm and 50 mm, respectively.

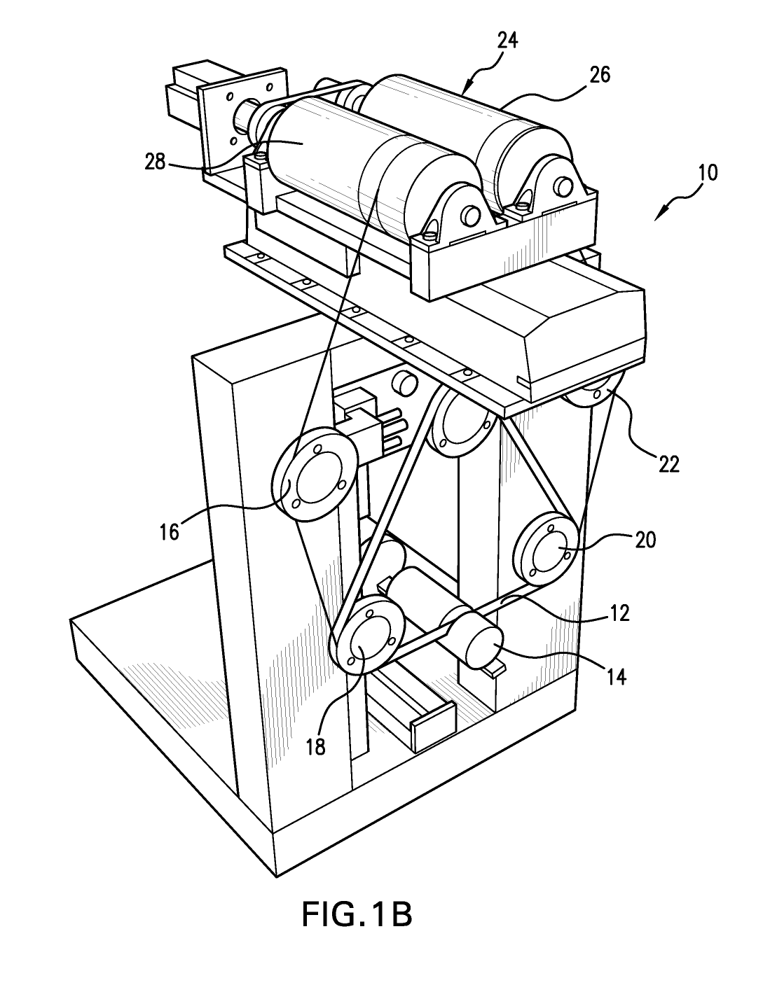

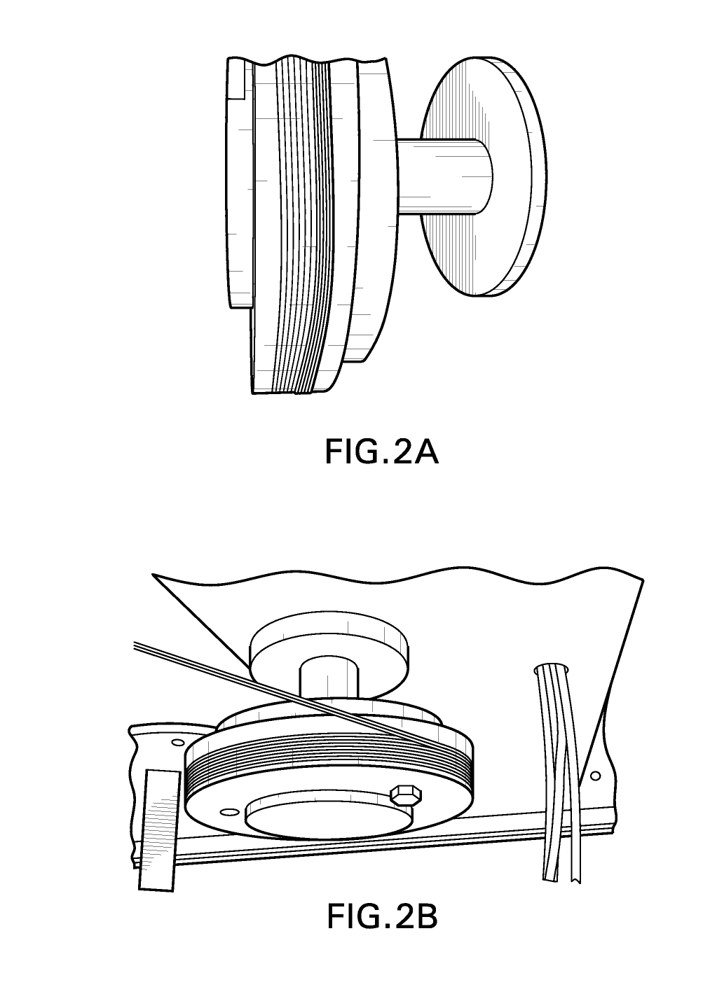

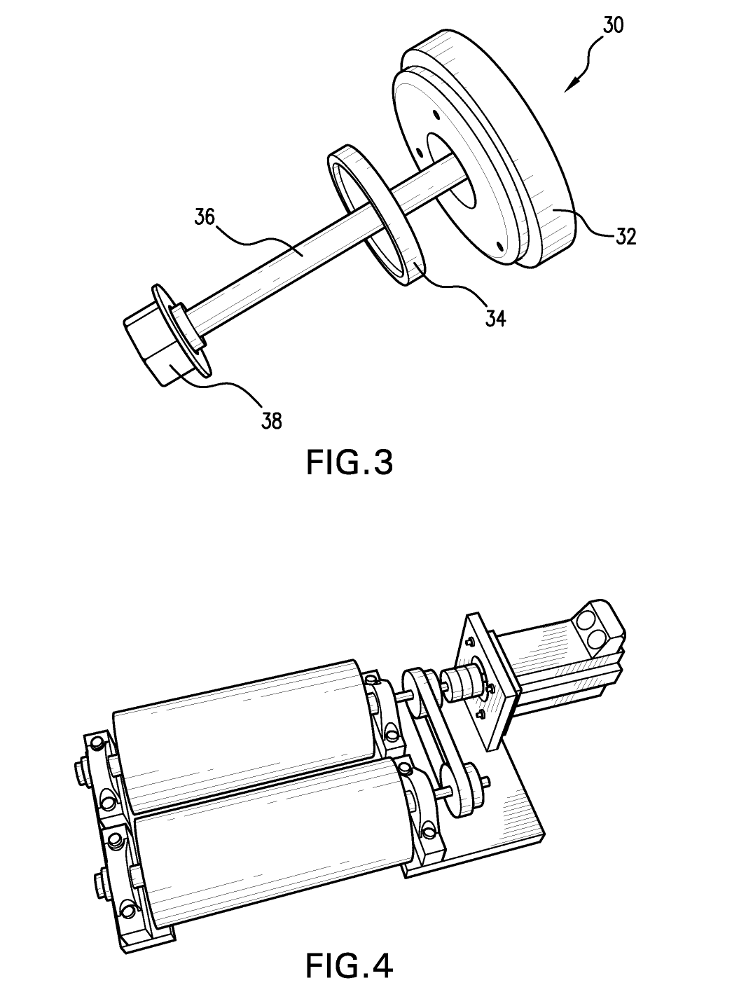

Views of a large contact diameter wire guide and the wire traveling along the wire guide are shown in FIGS. 2A and 2B. FIG. 3 is a view of wire guide device 30, including wire guide 32 mounted, together with flange 34, on rod 36. Wire guide device 30 can be provided with means 38 for affixing the device to a support, e.g., a machine wall. FIG. 4 is a view of single layer dual drum spooling assembly 24.

In preferred arrangements, a planar wire path assembly such as shown in FIGS. 1A and 1B, employs relatively large contact diameter wire guides and wire spooling devices such as those shown, for instance, in FIGS. 2A, 2B, 3 and/or 4.

Wire handling in an arrangement such as the fixed plane arrangement described above, as well as in many conventional arrangements typically involves wire spooling. Wire-on-wire abrasion, however, is a common problem in spooling devices used in existing fixed abrasive wire slicing machines, causing continuous damage and potentially reducing the usable life of the abrasive wire.

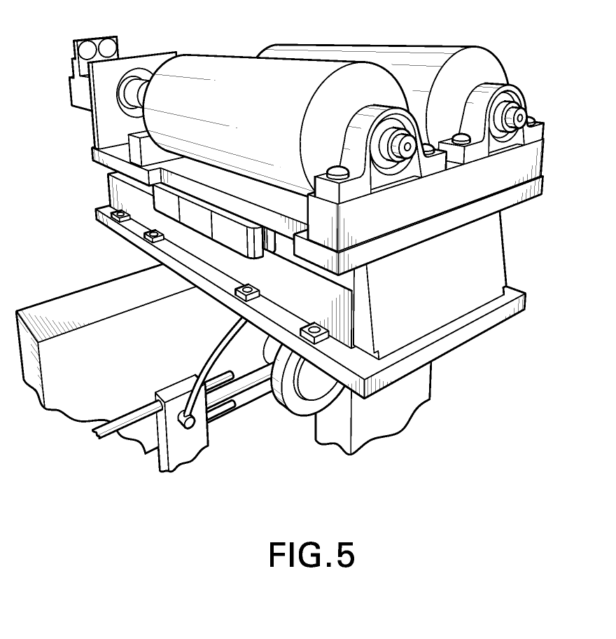

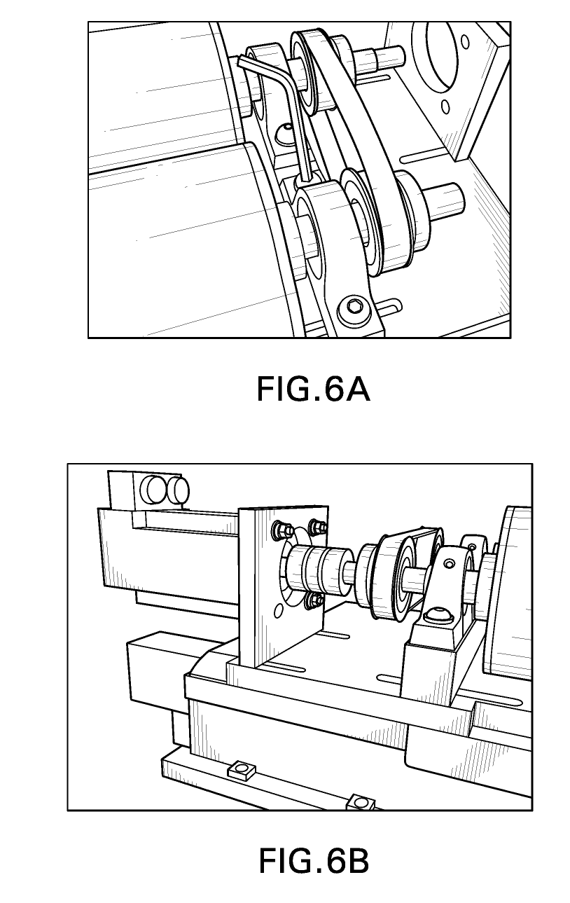

To address wire on wire abrasion and other problems, a single layer dual drum spooling assembly includes more than one roller linked together. In preferred implementations, two rollers are mechanically linked to each other by a timing belt that ensures that both rollers spin together in fixed rotation. A view of an illustrative single layer dual drum spooling assembly is presented in FIG. 5, while close-up views of the timing belt and means for securing the rollers to a frame are presented in FIGS. 6A, 6B, 6C.

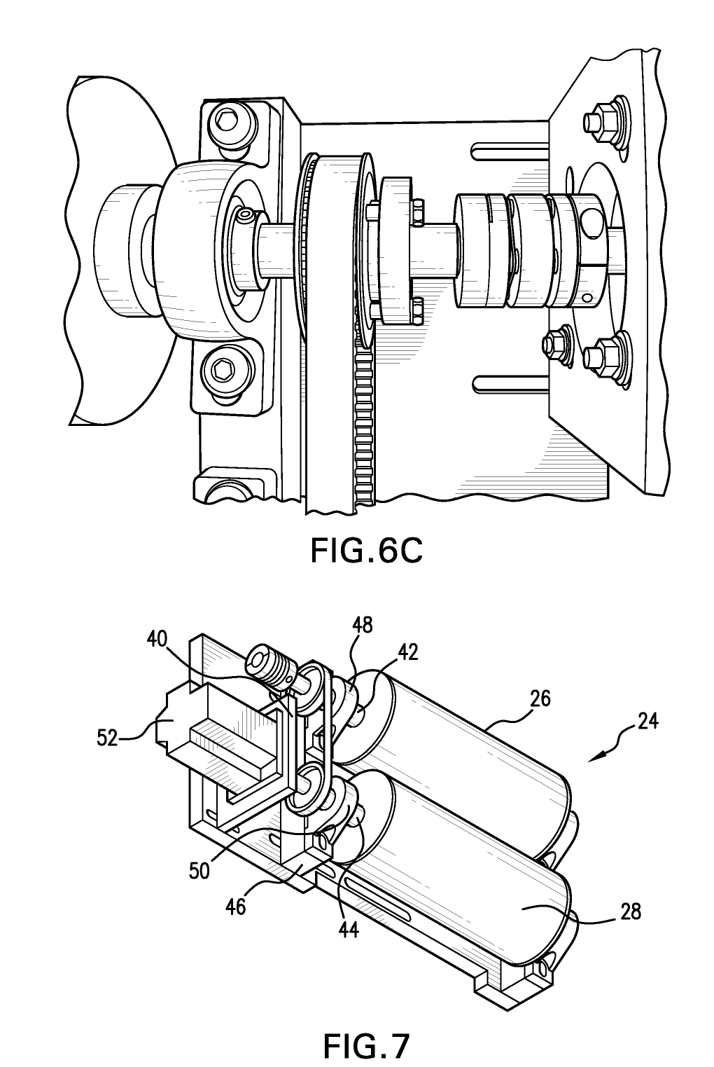

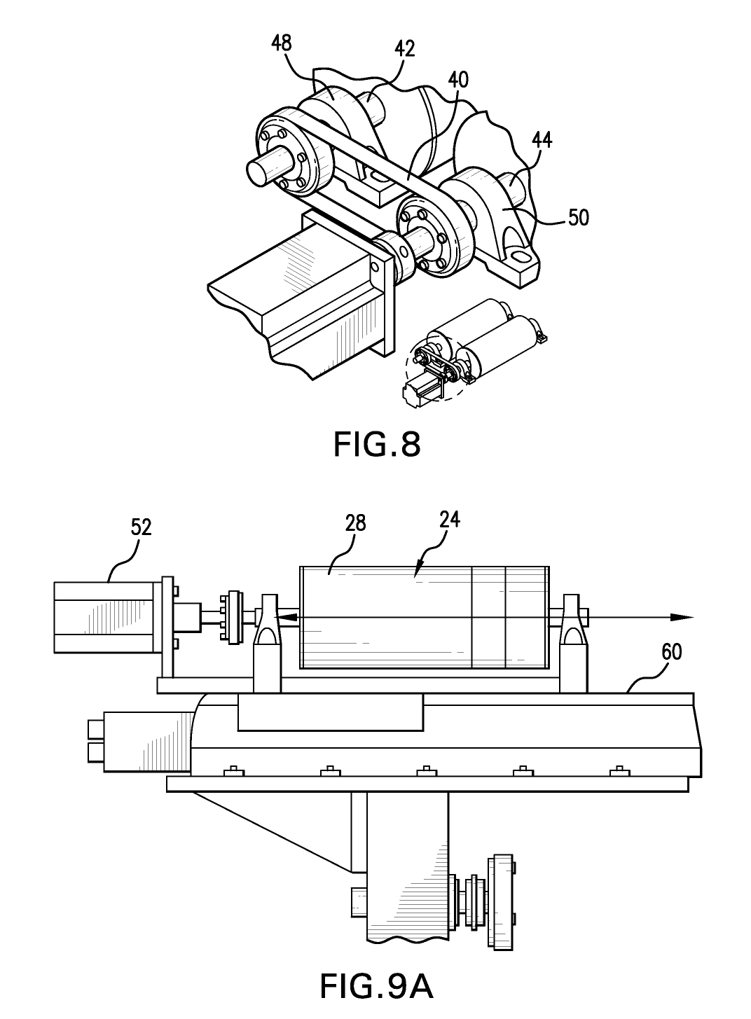

Shown in FIGS. 7 and 8 is single layer dual drum spooling assembly 24 including drums 26 and 28, linked together by timing belt 40. Drums 24 and 26 can be constructed from aluminum or another suitable material and preferably have a hollow core. To improve traction and reduce or minimize abrasive wear on the surface, one or both drums can be coated with urethane or with another suitable layer or film. Wire can be fixed to the spooling drums by simple clove-hitch knot and the friction of a few rotations of the wire, or by other suitable techniques.

Drums 24 and 26 are mounted, respectively, on shafts 42 and 44 which preferably are secured to bracket 46 by means such as, for instance, pillow block ball bearings 48 and 50.

In specific examples, shafts 42 and 44 are provided with timing sprockets for the timing belt and one of the shafts, e.g., shaft 44, is connected via a servo flexible coupling or other suitable means to servo motor 52 mounted to shaft 44.

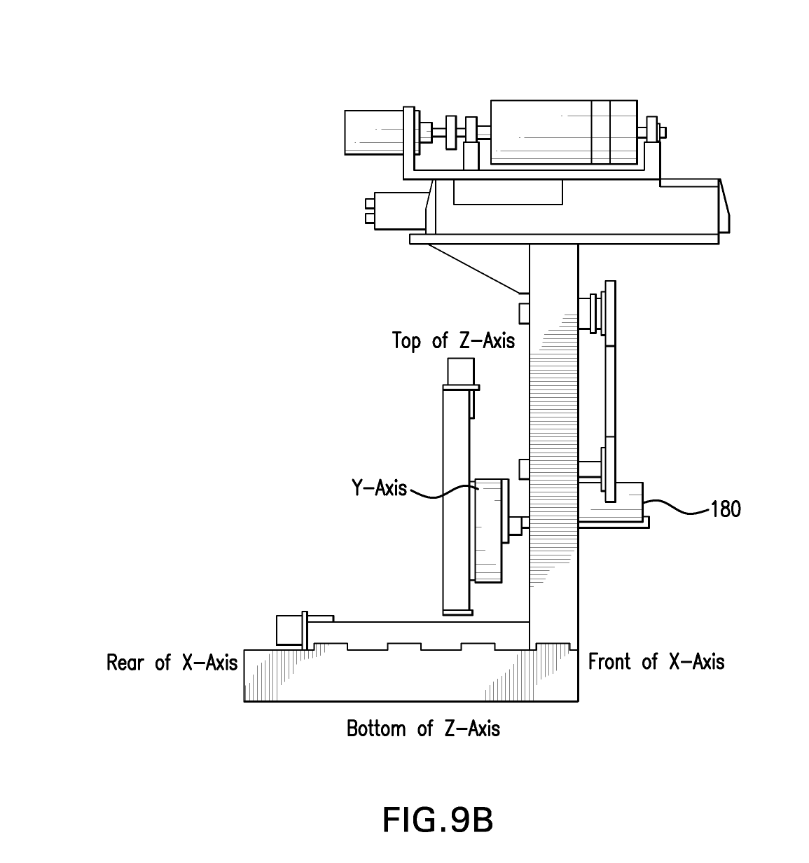

In specific implementations, shown, for instance in FIG. 9A, single layer dual drum spooling assembly 24 is mounted on linear stage 60, e.g., a high precision linear stage that allows for drums 26 and 28 to move forward and in reverse as shown by the arrow. In turn linear stage 60 preferably is mounted to the base of the wire slicing machine, above the wire guides as seen, e.g., in FIGS. 1A and 1B. The axes and the relationship with a workpiece, e.g., workpiece 180, are shown in more detail in FIG. 9B.

Preferably, the linear stage is also driven with a servo motor which is electronically geared to the spooling drum drive servo. The electronic gearing ratios can be software changed to account for different wire thicknesses.

During operation, as one roller is driven by the motor, the other roller moves in the same direction and speed due to the timing belt and the single layer dual drum spooling assembly allows for the wire to be wound onto the spools in a single layer. This is done with moving the drum as the wire is wound in a way such that the assembly travels one width of the wire per one rotation of the drums. In preferred implementations, the drums move only once in order to fill the entire length with a single layer of wire. In other embodiments, the spools are loaded with more than one layer of wire on their length. The loading can be thought of as somewhat analogous to a fishing reel which bobs up and down as the line is loaded to ensure an even layer of line on the reel. Further embodiments include a drum arrangement in which the pitch is controlled in both drums.

Yet other embodiments employ a dual servo motor arrangement, each motor being independently linked to a spooling drum. In addition to driving the wire, this arrangement can maintain tension on the follower drum, thus providing improved tension control over a pneumatic system.

During a slicing operation in which a workpiece such as an ingot is fed, for example, in an upward direction into the wire field, the workpiece pushes against the wire and, in the absence of adequate tension on the wire, would move the wire upwardly. To counteract this motion, the wire applies an equal and opposite force on the workpiece, resulting in slicing.

As ingots, or other workpieces, are fed upwardly, for instance by electromechanical systems, including, e.g., computer controlled linear stages, a feedback system can ensure that the workpiece is fed at an appropriate speed. Otherwise, if an ingot is fed too quickly, the cutting rate can become less than the feed rate and the wire is likely to break, limiting the usefulness of the wire and causing interruptions in the manufacturing process.

The embodiment described below addresses these potential wire ruptures and other problems by limiting the bow angle of the wire in order to achieve a constant force situation, thereby controlling the slicing operation and thus reducing or eliminating the wire breakages described above.

In one implementation, a constant force wire bow sensor is designed around a wire tracking device which can be a ball bearing roller, preferably of a relatively small size. In specific examples, the roller is located above the cut, so that, if the wire or wire field is pushed up with the workpiece, the roller consequently follows, moving in the same direction.

Several sensing and/or detection techniques can be employed to monitor the movement of the ball bearing roller. In a preferred implementation, the roller can be fixed to a pivot arm which rotates around a fulcrum point. The opposite end of the arm is extended and terminated with a small mechanical flag which moves up and down with the pivot arm. The flag can be used to break the beam of an opto-electronic light gate sensor. In specific examples, the position of the sensor is controlled so that the light beam breaking point can be changed, allowing for setting of different maximum bow angles of the wire to trigger the sensor, which is also indicative of setting a different constant force on the wire. This approach can be used to indicate a maximum force on the wire. In further implementations, the sensor is linked to a feedback loop via the programmable logic controller (PLC) of the system and serves to stop the feed of the workpiece, should the cut rate become less than the feed rate of the workpiece. In preferred implementations, this results in an equilibrium point where the workpiece is only fed up to a point where the maximum angle sensor is not interrupted.

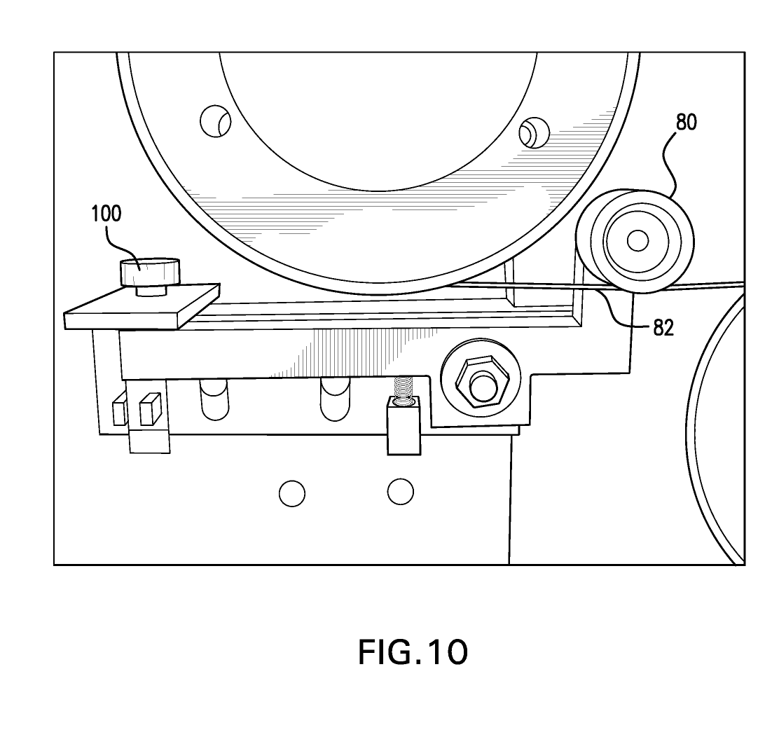

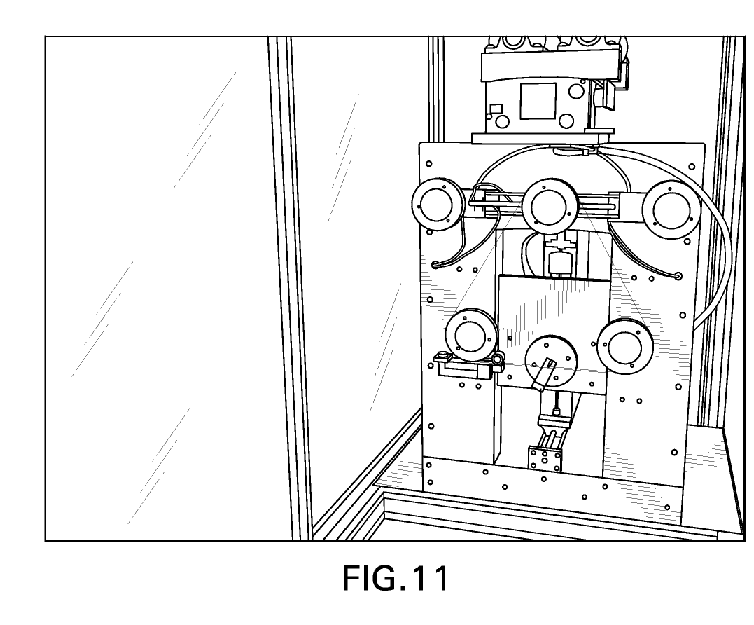

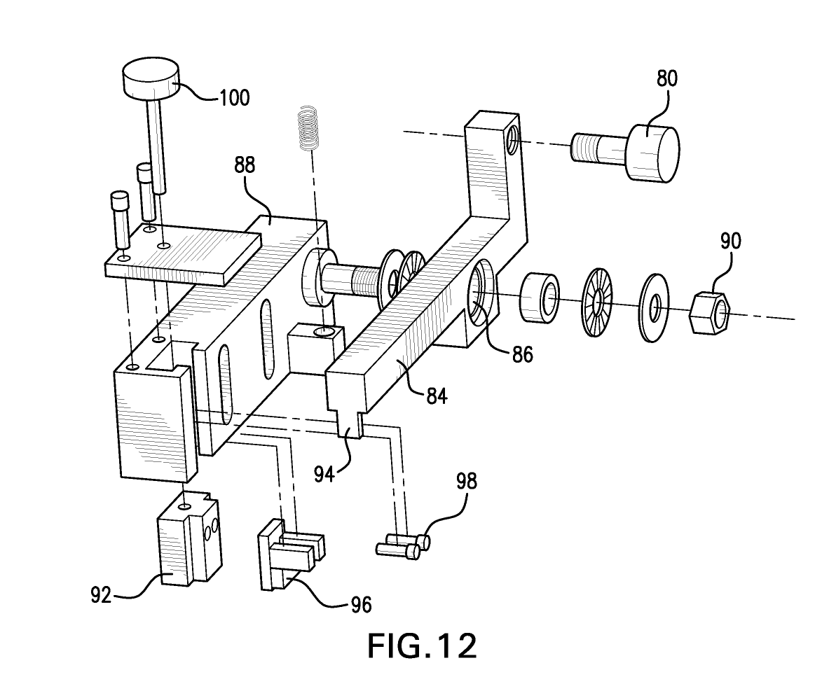

Views showing a wire constant force sensor system such as described above are presented in FIGS. 10 and 11, and an exploded view is provided in FIG. 12. The system includes roller 80, such as a small ball bearing roller discussed above, which sits directly on top of wire 82, which can be seen, e.g., in the image shown in FIG. 10. As seen in FIG. 12, the fulcrum point 86 of pivot arm 84 can be attached to support 88 using e.g., hexagonal nut 90 and suitable washers, spacers, and other mounting devices known in the art. Support 88 also houses sensor 92, which can be provided with elements 96 and 98, for detecting protrusion 94 of pivot arm 86. Location of sensor 92 can be adjusted via knob 100, e.g., a threaded thumb screw resting on plate 102. In turn, plate 102 can be mounted on support 88 by screws or other suitable means.

The constant force sensing technique described herein also can be used in arrangements in which the workpiece is moved in a downward direction. For down-feed slicing, the constant force sensor is modified to accommodate the tracking roller for the wire bow which is moved below the wire, to account for negative bow.

Wire sawing conducted, for example, with a fixed diamond wire such as described above, can be employed to produce shapes other than the flat slices obtained in typical wafering processes. In some aspects, the invention relates to curvilinear slicing of thin shapes and/or complex geometry profiling.

In one implementation, the slicing operation utilizes multi-axis motion on a wire saw to produce a curvilinear slicing profile and to generate curved wafers. In another implementation, the workpiece is rotated during the curvilinear slicing described above to achieve a complex shape such as, for example, a dome, as the wire grinds out material in the workpiece.

In a complex curvilinear slicing process that uses, e.g., fixed diamond abrasive wire slicing equipment, a multi axis motion on a wire saw can generate curved wafers by controlling both the X and Z axis during the cutting process. As the wire is fed through the workpiece, the X axis can be interpolated simultaneously to create a curvature in the component. If the workpiece is also rotated during this curvilinear motion, a complex shape can be achieved.

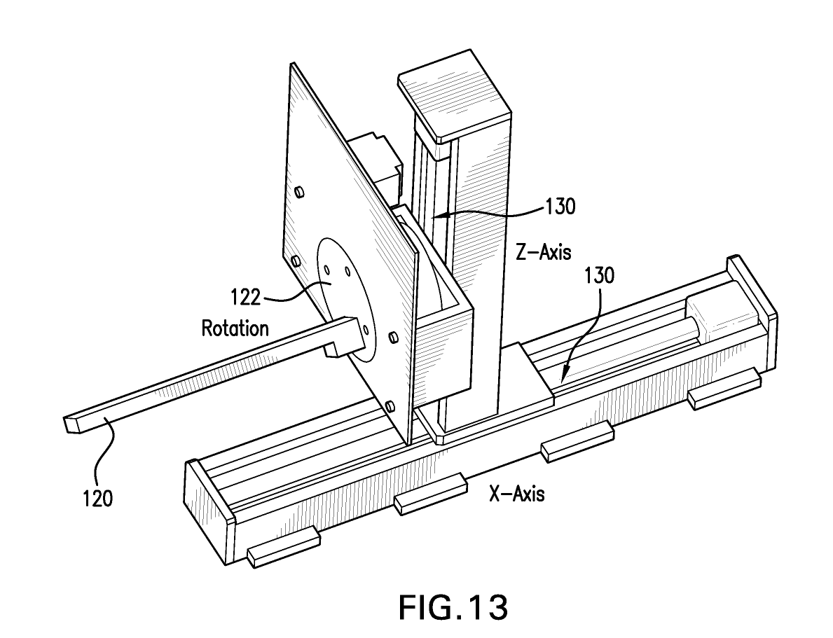

The positioning of the X and Z axes and the rotation of the workpiece on a wire slicing assembly are shown, for example, in FIG. 13. The workpiece can be mounted on bar 120, using a suitable medium such as, for example, hot wax or a suitable adhesive material. Bar 120 is mounted or is part of rotating table 122. As seen in FIG. 13, rotating table 122 can move in the x direction and the z direction via mechanisms 130 and 132, respectively. Linear stages or other arrangements can be employed to provide the motion along the X and/or Z and/or rotational axes.

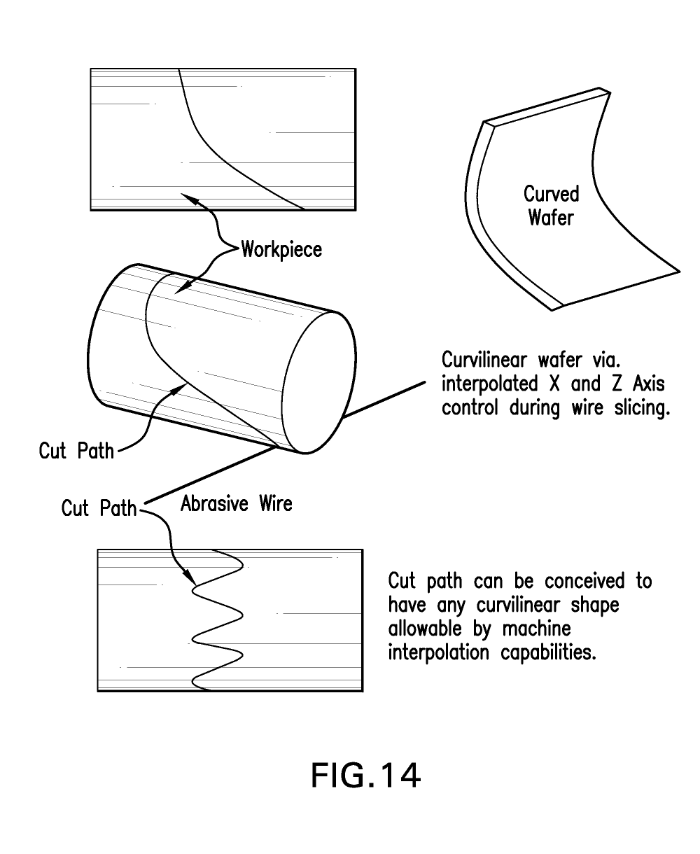

Shown in FIG. 14 is a cut path that can be followed during slicing a workpiece by interpolated X and Z axis control during slicing. The cut path can have any curvilinear shape allowable by machine interpolation capabilities.

Also shown in FIG. 14 is an exemplary curved wafer that can be produced using the interpolation technique described herein.

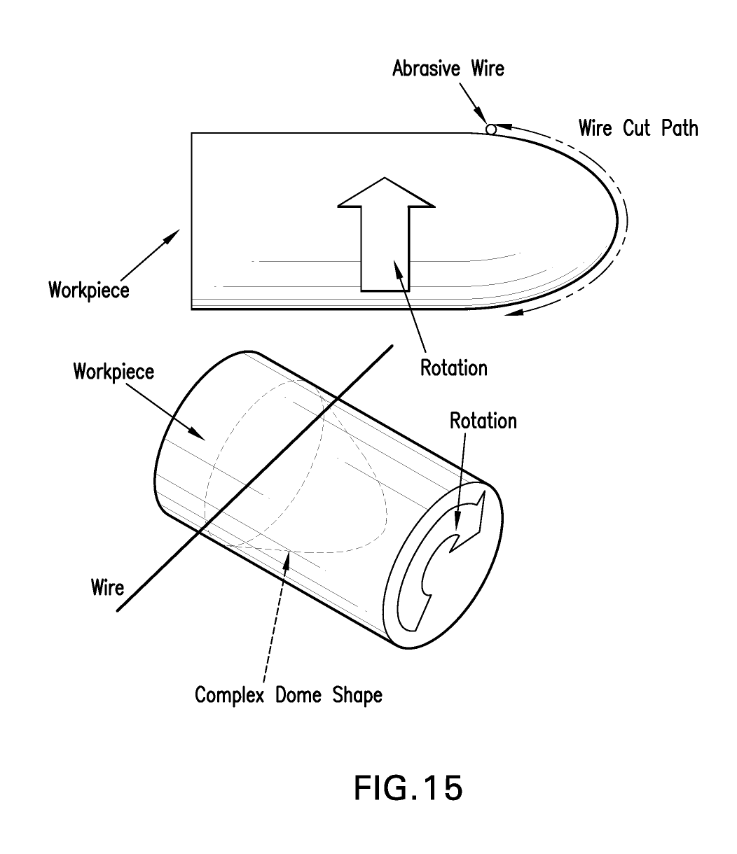

By also rotating the workpiece, a complex shape can be formed as illustrated with respect to the exemplary dome shape shown in FIG. 15. Illustrative rotational speeds can be within the range of from about 1 rotation per minute (RPM) to about 200 RPM.

While the curvilinear slicing of thin shapes and the complex geometry profiling described herein is particularly attractive in abrasive wire sawing operations, these techniques also can be used in military applications such as radar domes or vision systems. Curvilinear viewing glasses can have vast applications such as curved viewing windows into harsh environments. Curved sapphire wafers could be used in high end watch applications with elegant scratch resistant crystals.

In conventional wire sawing machines, rocking is created by rocking the wire guide assembly. In contrast, further embodiments of the invention relate to rocking and rotating the workpiece, e.g., ingot, during the wire slicing operation. Conveniently, the assembly employed can be the same or similar to that employed in curvilinear slicing and complex geometry profiling discussed above. In preferred implementations, the assembly employs an electromechanical rotary stage.

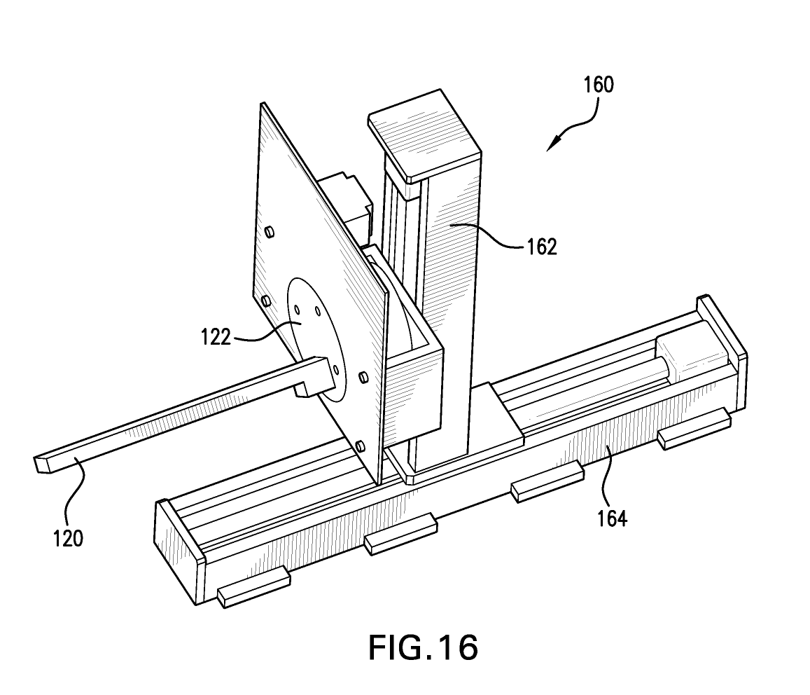

Shown in FIG. 16 is three-dimensional image of the entire ingot movement and feeding assembly 160, including two linear stages 162 and 164 and a rotary stage, e.g., rotating table 122, which is mounted on vertical stage 162. Use of an electromechanical rotary stage allows for the workpiece mount bar, e.g., bar 120, to rock and rotate. For full rotation, bar 120 can be replaced by other tooling such as center type fixturing, which can hold the workpiece in a cantilevered arrangement.

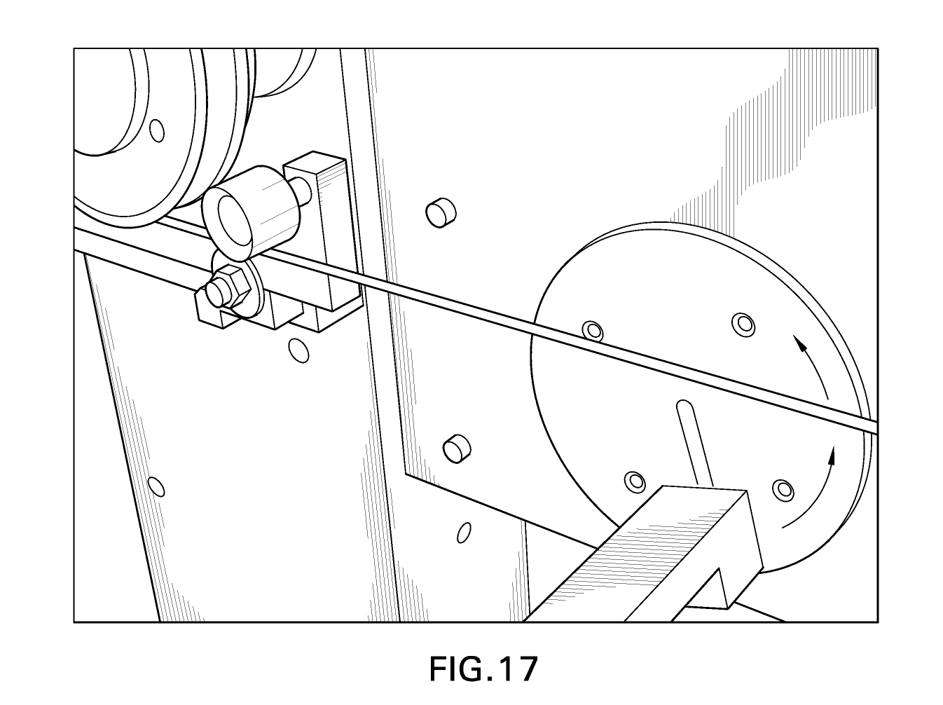

An image of rotating table 122, with protruding bar 120 that can be used to affix a workpiece using, for instance, hot wax, adhesives or another suitable medium, is shown in FIG. 17. During operation, the entire protruding tooling bar is fed into the wire and the embodiment described herein allows the workpiece to be either rocked or rotated 360 degrees as the workpiece is fed, decreasing the cutting contact length and thereby increasing the force per grit.

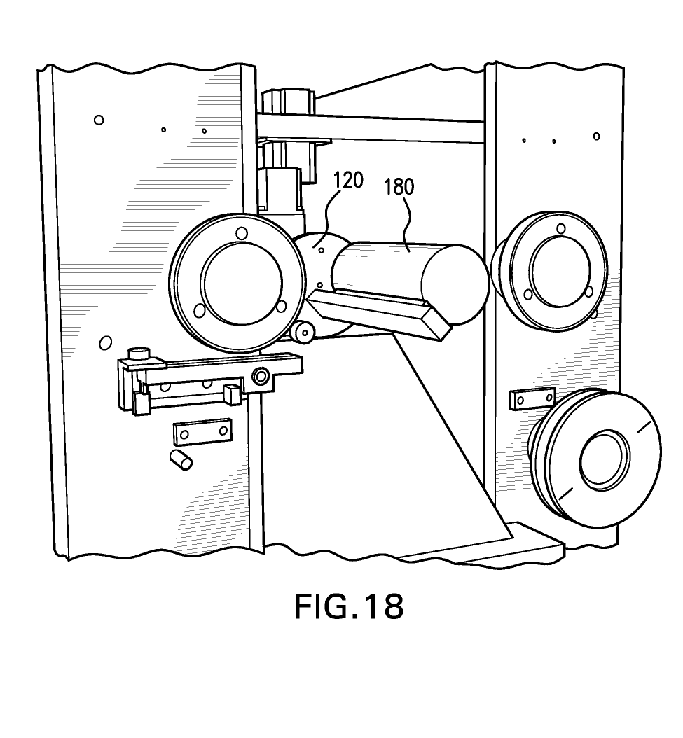

A mounted workpiece, e.g., ingot 80, that is being rocked on the rotary stage, e.g., rotating table 120 described above, is shown in FIG. 18.

In specific implementations, the rotary stage is driven by a stepper motor and a stepper motor controller chosen preferably allows for the flexibility of complex rotary path programming, including acceleration and rotational speeds. A stepper motor with sufficient torque to account for forces present during slicing is preferred.

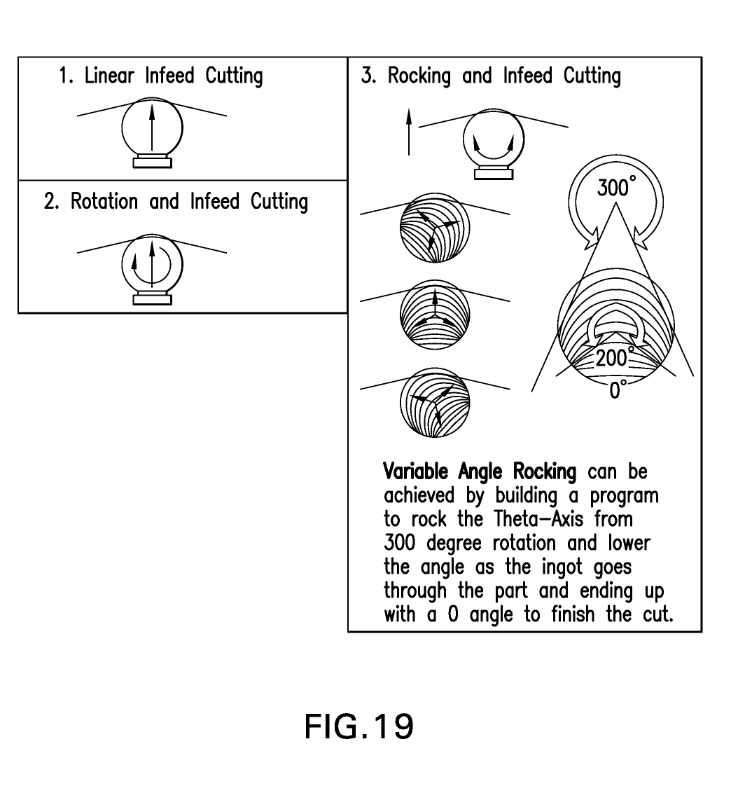

Diagrams for comparing (1) linear infeed cutting, (2) rotation and infeed cutting, and (3) rocking and infeed cutting are shown in FIG. 19. With respect to diagram 3 (rocking and infeed cutting), variable angle rocking can be achieved by building a program to rock the Rotational Axis from 300 degrees rotation and lower the angle as the ingot goes through the part and ending up with a 0 degree angle to finish the cut.

The approach described herein allows for any rocking angle, for speeds of up to 100 rotations per minute (RPM), and/or for full 360 degree rotation with same rotational speeds.

Advantages of the process capabilities described here include equalizing the contact length of the wire throughout the cutting process, and maximizing the force per grit. A rocking process can be thought of as analogous to sawing a log by hand and rocking the saw forward and backward to speed up the cut. Rotation of the workpiece also can increase the force per grit as well as increase the relative wire to workpiece contact speed if the rotation is sufficiently increased.

In further embodiments, the invention is directed to an abrasive wire slicing system or machine that includes one or more of the features and/or techniques described above. In specific implementations, the system includes at least one and preferably more than one of: low bending spooling; single layer dual drum spooling assembly single layer spooling; constant force wire bow sensor; capabilities for curvilinear slicing of thin shapes and/or complex geometry profiling; workpiece rocking and rotation; and high tension and high wire speed. Preferred implementations simultaneously combine all these features.

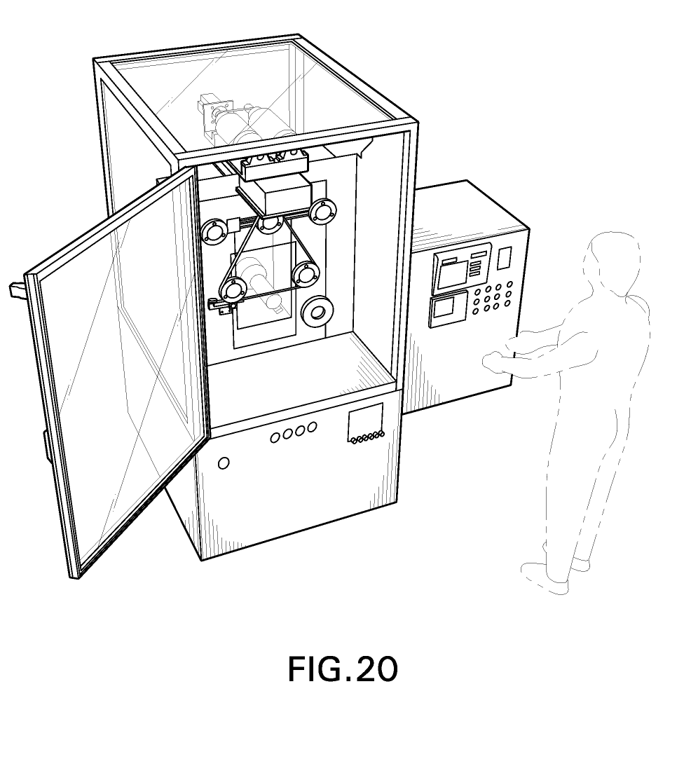

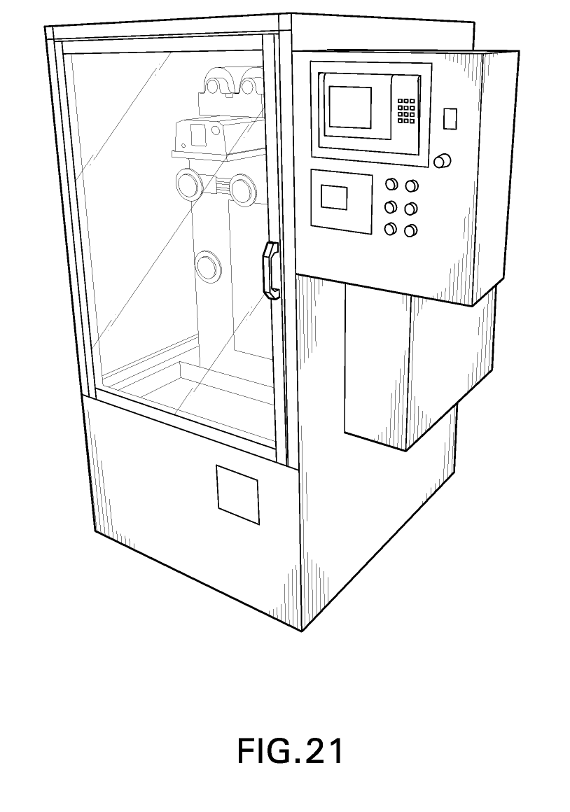

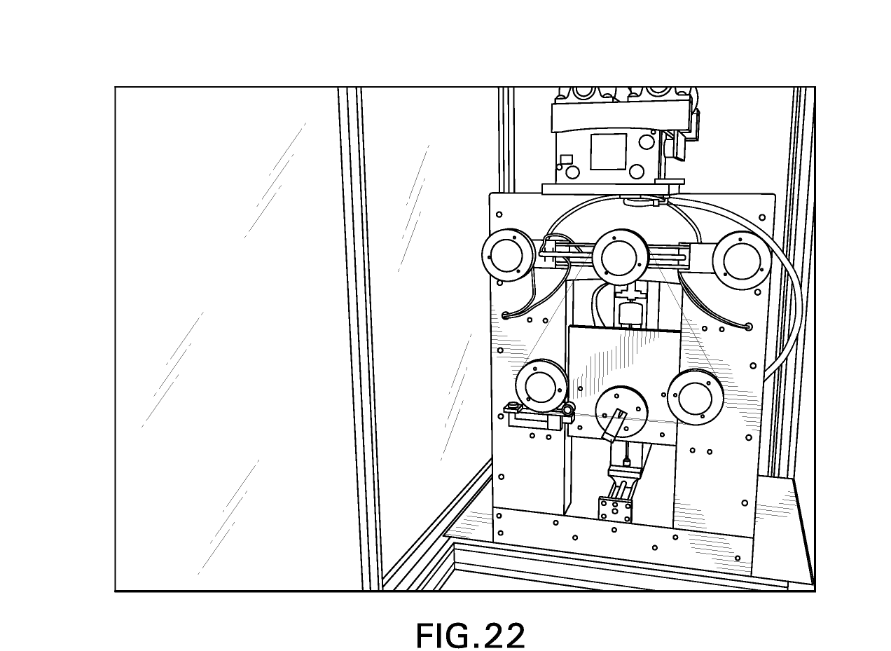

Specific examples of the wire slicing system are shown in FIGS. 20, 21 and 22. Shown in FIG. 20, for example, is a three-dimensional image of several designed components assembled in a 3D virtual space. FIGS. 21 and 22 are views of a system including wire guides, wire spooling rollers, wire tensioners, seen, e.g., with the door cover open.

The system disclosed herein preferably employs diamond wire such as described above and is particularly useful in slicing hard ceramics for the semiconductor industry, e.g., during wafering. In some implementations, the system disclosed herein is provided with tooling that can be interchanged between single- and multi-wire slicing. Tooling with different pitch and amounts of grooves also can be provided.

The system preferably employs a wire spooling system modified to account for larger single layer spooling lengths. Likewise, the timing belt wire spooling drum drive arrangement described above can be modified to use dual servo system, where one servo acts as the drive motor while the other behaves as a break, thus eliminating separate tensioning systems and allowing for fluctuations in wire spooling OD changes on the spools. The servos switch between drive and break when the direction of the wire is reversed, such as in forward and reverse slicing.

In many cases the workpiece moves upwardly into the wire(s). The system also can be designed so that the workpiece is fed downwardly into the wire(s), allowing for efficient swarf removal. For down-feed slicing, the constant force sensor is modified to accommodate the tracking roller for the wire bow which is moved below the wire, to account for negative bow.

Regardless of the direction in which the workpiece is fed, preferred implementations of the invention allow for the workpiece to move up and down, forward and backward, rotate and/or rock during the slicing process. A constant force system is provided for better control of the cutting process.

The system can be designed to have versatile capability for slicing using constant force as well as constant feed programs. Constant feed programs are programmable with variable feed rates which can be varied with the depth of cut or elapsed time.

One or more computer programs can be added to incrementally step the wire advancement to expose new wire over time, to ensure constant kerf and consistent sharpness of the wire. This capability can be utilized to a program where wire usage is stepped continuously forward to expose new wires during cutting. This may be especially beneficial if the length of the wire is very long and a continuous slicing mode is necessary, such as in a production environment.

The system preferably incorporates cooling of the slicing zone. In preferred examples, cooling fluid is delivered via coherent jet nozzle technology, as described, for instance, in U.S. Pat. No. 6,669,118 B2 and issued on Dec. 30, 2003 and U.S. Pat. No. 7,086,930 B2, issued on Aug. 8, 2006, both to Webster, both having the title of Coherent Jet Nozzles for Grinding Applications, the teachings of both being incorporated herein by reference in their entirety.

For instance, cooling fluid can be delivered via a nozzle assembly that includes a plenum chamber; a modular front plate removably fastened to a downstream side of said plenum chamber; at least one coherent jet nozzle disposed for transmitting fluid through said modular front plate; the coherent jet nozzle having a proximal end portion having a downstream axis and a transverse dimension D; a distal end portion; the distal end portion decreasing in transverse dimension in the downstream direction; the distal end portion terminating at an outlet having a transverse dimension d; wherein the ratio D:d is at least about 2:1; and a conditioner disposed within said plenum chamber. In other arrangements, the nozzle assembly includes: a plenum chamber; a modular card removably fastenable to a downstream side of said plenum chamber; at least one coherent jet nozzle disposed within said card for transmitting fluid from said plenum chamber therethrough; the at least one coherent jet nozzle being configured to generate a spray that increases in transverse dimension by no more than about 4 times over a distance of about 30.5 cm from the nozzle; and a conditioner disposed within said plenum chamber. In further arrangements the nozzle assembly includes: means for providing a plenum chamber; nozzle means for generating a spray that increases in transverse dimension by no more than about 4 times over a distance of about 30.5 cm; means for removably coupling the nozzle means to a downstream side of said plenum chamber means; and means for conditioning fluid disposed within said plenum chamber.

In preferred embodiments, cooling is provided by a method for delivering a coherent jet of grinding coolant to the method including: a) determining a desired flowrate of coolant for the grinding operation; b) determining coolant pressure required to generate a coolant jet speed, for example approximately equal to the peripheral wire speed at the coolant flowrate; c) determining a nozzle discharge area capable of achieving the coolant jet speed; and d) providing a nozzle assembly for delivery of a coherent jet of a grinding coolant at the coolant jet speed, wherein the nozzle assembly comprises a plenum means and at least one nozzle, the nozzle comprising an axis, a proximal end having a maximum dimension D, and a distal end portion containing the nozzle discharge area having a longitudinal cross-section of dimension d; the distal portion having a surface disposed at an angle of at least 30 degrees relative to the axis; and the nozzle characterized by a D:d ratio of at least about 2:1.

Other suitable cooling arrangements can be employed.

The system also can be implemented with software capabilities that will allow for further process control. This includes early wire breakage detection, by continuously monitoring the power from the drive servo and from the digital control proportion valve used to control the wire tension. By monitoring wire tension and elongation potential wire breakage situations can be detected and the machine can be instructed to stop cutting and back out of the cut.

A digital feedback system can be used for the constant force sensor. As described above, a machine that is equipped with a sensor which detects the maximum force condition during the cut and instructs the feed mechanism to pause, until the slicing rate relaxes the wire such that the sensor is deactivated. This approach, which works on the principle of translating the bow of the wire during slicing to a maximum cutting force, can be further refined or modified to continuously monitor the bow angle, not just the maximum. Such a modification would allow for complex process control and variable force slicing through ingots. A variable force program would potentially be beneficial in slicing objects with a changing wire contact length through the cut profile. Round ingots exhibit this as the contract length changes from 0 to OD of the part through the cut.

Advantageously, the system disclosed herein can incorporate unique handling of the workpiece which allows for versatility in the slicing process. An ingot can be moved up and down, forward and backward as well as rotated or rocked during slicing. As described above, a unique method of handling and spooling of the wire minimizes the amount of bending the wire and eliminates overlapping of the wire which has been liked to wire breakage.

Examples of the system described herein can reach a wire speed of 15 m/s and can have a tension range of up to 50N. When compared to existing abrasive wire slicing machines, specific implementations of the system can provide faster cutting rates and cuts of improved quality.

An illustrative fixed abrasive wire slicing machine specification is presented in Table 1 below.

TABLE 1
Machine Base

| | |
|---|---|
| material | low vibration granite |
| general shape | 100 mm horizontal base with 75 mm vertical wire guide |
| | member |

Core Slicing Unit

| | |
|---|---|
| Wire Feed | 0-15 m/s |
| Wire Tension | 0-50 N |
| Tensioning System | pneumatic spring and damper system |
| Spool Wire Length | 50-2000 m |
| Slicing Cycle Control | programmable cycle with forward and reverse operation |
| Spooling System | indexing spools for non-overlap wire spooling |
| Coolant System | coherent nozzle coolant delivery |
| Enclosure | fully enclosed system with coolant guarding |

Workpiece Handling

| | |
|---|---|
| Workpiece Motion | X, Z, θ - Axis |
| Axis Positioning Accuracy | +/−5 to 30 μm at workpiece |
| Axis Repeatability Accuracy | +/−2 to 5 μm at workpiece |
| Positioning Control | CNC - touch-screen LCD panel control |
| Cut Location Indexing | fully programmable or manual via digital controller |
| Workpiece Motion | rocking & rotating with variable rotation positioning |
| | control |
| Constant Force | upgradable to constant force infeed |
| Workpiece Size | up to 8″ OD × 12″ long (square or round) |
| Workpiece Mount | customizable |
| Workpiece Feed | constant feed and constant force |

Safety

| | |
|---|---|
| E-Stop | 2-3 locations on machine |
| Fail Safe Operation | machine lockout, automatic shutdown with open doors |
| Guarding | fully enclosed with clear work operation windows |

While this invention has been particularly shown and described with references to preferred embodiments thereof, it will be understood by those skilled in the art that various changes in form and details may be made therein without departing from the scope of the invention encompassed by the appended claims.

1. A fixed abrasive wire slicing system comprising one or more of:
a) an essentially planar wire path for providing a fixed abrasive wire to a cutting zone;
b) a contact element having a contact diameter greater than 100 mm;
c) a single layer dual drum spooling assembly including operationally linked rollers, one of said rollers being connected to a motor;
d) a system for monitoring a bow angle on a slicing wire contacting a workpiece, wherein the system for monitoring the bow angle includes a detector for sensing movement of a device tracking bowing of the wire at the slicing zone;
and
e) an assembly including a first linear stage and a rotary stage mounted on a second linear stage, wherein the second linear stage is different from the first linear stage.

2. The fixed abrasive wire slicing system of claim 1, further comprising a cooling system.

3. The fixed abrasive wire slicing system of claim 2, wherein the cooling system includes at least one coherent jet nozzle.

4-13. (canceled)

14. The system of claim 1, wherein a the essentially planar wire path is defined by the one or more wire spools, wire guides or wire tensioners.

15. (canceled)

16. The system of claim 1, wherein the essentially planar wire path includes at least one contact element selected from the group consisting of spool, wire guide and wire tensioner.

17-23. (canceled)

24. The system of claim 1, wherein the single layer dual drum spooling assembly is mounted on a linear stage.

25-36. (canceled)

37. The system of claim 1, wherein the device tracking bowing of the wire is a ball bearing roller mounted on a pivot arm rotatable around a fulcrum point, and the detector for sensing movement of the device is capable of sensing a probe mounted at an opposite end of the pivot arm.

38. The system of claim 1, further comprising means for stopping feeding the workpiece into the slicing wire if the bow angle sensed by the detector reaches a set bow angle value.

39-46. (canceled)

47. The system of claim 1, wherein the second linear stage is vertical.

48. The system of claim 1, wherein the rotary stage is driven by a stepper motor.

49. The system of claim 1, further comprising means for controlling a rocking angle of the workpiece during a slicing operation.

50. (canceled)

51. A method for wire slicing a workpiece, the method comprising one or more of processes selected from a group consisting of:
a) a process for monitoring or controlling a bow angle, wherein the process includes:
i) selecting a set value for a bow angle caused by contact between a wire and a workpiece; and
ii) detecting an actual bow angle during wire slicing to determine if the actual bow angle reaches the set value;
b) a process for providing wire to a cutting zone by moving a fixed abrasive wire back and forth between two drums, wherein pitch is controlled in both drums;
c) a process for providing wire to a cutting zone, the process including rotating a first roller, wherein the first roller is operationally linked to a second roller, to wind wire on said rollers and said rollers are mounted on a linear stage and travel one width of the wire per rotation of said rollers;
c) a process for producing a curvilinear cut in a workpiece, the process comprising controlling a first axis and a second axis during wire slicing while interpolating the first axis as a wire is fed through the workpiece; and
d) rocking the workpiece while the workpiece is being fed into a fixed abrasive wire.

52. The method of claim 51, wherein process (a) further comprises stopping the wire slicing if the actual bow angle reaches the set value.

53. The method of claim 51, wherein process (c) further comprises rotating the workpiece to produce a complex geometric profiling.

54. The method of claim 51, wherein in process (c) the workpiece is mounted on linear stages capable of moving along the first axis and along the second axes, respectively.

55. The method of claim 51, wherein rocking is conducted at a variable angle.

56. A workpiece produced by the method of claim 51.

57. A fixed abrasive wire slicing system comprising one or more of:
a) a fixed abrasive wire handling assembly including one or more wire spools, wire guides or wire tensioners, wherein a wire path defined by said spools, wire guides or wire tensioners is essentially planar;
b) linear stages for controlling, respectively, a first axis and a second axis and a table for rotaing a workpiece during a slicing operation; or
c) a dual drum assembly for controlling a wire pitch on both drums, said assembly including a first roller and a second roller, said rollers being operationally linked to one another, at least one of the first roller and second roller being connected to a motor.

58. The system of claim 57, wherein the wire pitch on the first roller is controlled independently from the wire pitch on the second roller.

59. The system of claim 57, wherein one or both of the first roller and the second roller support a single layer of fixed abrasive wire.

60. The system of claim 57, wherein one or both of the first roller and the second roller support more than a single layer of fixed abrasive wire.
